(19) United States
(12) Patent Application Publication
(10) Pub. No.: US 2005/0071236 A1
(43) Pub. Date: Mar. 31, 2005

(54) System and business method for memorializing vehicle purchase transactions

(75) Inventors: Gerald Lacour, Leander, TX (US); Garrett Lacour, Leander, TX (US); Robert Corbin, Leander, TX (US); Matt Nowicki, Leander, TX (US)

Correspondence Address: DAVID G. HENRY, 900 Washington Avenue, P.O. Box 1470, Waco, TX, 76701, US

(73) Assignee: Innovative Aftermarket Systems, LP

(21) Appl. No.: 10/901,892

(22) Filed: Jul. 29, 2004

Related U.S. Application Data
(63) Continuation of application No. 10/060,033, filed on Jan. 28, 2002.
(63) Continuation of application No. 10/060,027, filed on Jan. 28, 2002.

(51) Int. Cl. G06F 17/60

(52) U.S. Cl. 705/24; 705/1

(57) ABSTRACT

A computer-based system and business method for recording vehicle purchase transactions involving sales staff and customers. The method involves, through use of a software-driven program on a PC and corresponding server software operating on a remote server, recording audio and video data using a PC-connected digital video camera and PC-connected microphone, generating transaction-specific data to be saved with the audio and video data, transmitting the transaction-specific data, audio, and video data to a remote server for storage, cataloging, and for later search/retrieval if needed by end users. An improved internet protocol (designated SENIP) is employed for enhanced data security in all client/server data transactions.

### CITATION TO PARENT APPLICATION(S)

This is a continuation-in-part with respect to U.S. patent applications Ser. Nos. 10/060,033 and 10/060,027, from which priority is claimed pursuant to 3.5 U.S.C. 120.

### BACKGROUND OF THE INVENTION

1. Field of The Invention

The present invention relates to business methods, and business methods in the vehicle sales area in particular.

2. Background Information

The vehicle sales arena is an area in which allegations of fraud and unfair sales tactics are rampant. The combination of aggressive sales staff and often unsophisticated purchasers is a volatile combination which often leads to claims against dealerships under the states' various consumer protection statutes and regulations.

Specific sources of dealership and customer conflicts include, among other things, such things as the total cost for a vehicle, the added costs for after-market products and warranty protections, the duration and scope of manufacturer's warranties, perceived promises as to performance or features of the purchased vehicle, the affect of credit given for trade-in vehicles on the ultimate purchase price of the subject vehicle, and the requirements for enrolling in, or making claims under add-on warranty programs (window etching, alarm system warranties, etc.).

When disputes arise between dealerships and customers, they often descend to the level of a “swearing match” between the “big bad car dealer” and the “poor victim customer.” Regardless of the actual facts, and what the customer was told (often times, multiple times), the dealership loses in court, or at least undertakes an expensive defense with no possible remedy when the truth prevails.

For the above reasons alone, it would be beneficial to provide, not just some manner for recording the interchange between sales staff and vehicle purchase customers, but to provide a recording system which produces substantially indelible records which are easily retrieved when needed.

In addition to providing protection for dealerships in the legal context, such a transaction recording system will enable supervisors to critique and train sales staff with respect to their demeanor and presentation when dealing with customers, as well as assure that all things within the staff member's responsibilities are being fulfilled (the offer of after-market programs and products, for example).

Further still, such a transaction recording system will actually protect customers in many cases. The stress of a major purchase, the frustration of unrealized expectations, and merely the passage of time can all contribute to flawed memory. A customer may well, honestly believe that one thing was promised, or another was never revealed, only to find out, when viewing the recorded transaction, that memory has played a trick. Such a customer will then avoid the costly and embarrassing experience of seeking legal relief against the dealership, only to find out that there was never a legitimate complaint.

The present inventors have invented an earlier version of a system for memorializing vehicle transactions. While the system and methods of the prior invention were a clear advance over anything then-existing in the marketplace, there were limitations related to long-term access to data by users. Video and other data collected via the prior system, at least in part, would of necessity arising from storage limitations of most private businesses' computers, require removal from the recording computer systems and archiving on non-volatile media (such as CDs or DVDs). Need for video and other data after a relatively short period of time would, therefore, require locating the storage media which (hopefully) would not have been misplaced and/or damaged (such as CDs and DVDs somewhat readily are).

In view of the foregoing, it would well-serve the vehicle sales industry and its customers alike to provide a business method and associated apparatuses which would allow the recording, the substantially indelible archiving, and easily operated cataloging of recorded transactions between sales staff and customers.

### SUMMARY OF THE INVENTION

In view of the foregoing, it is an object of the present invention to provide a novel transaction recordation system and associated business method which benefits automobile dealers and customers.

It is another object of the present invention to provide a novel transaction recordation system and associated business method for conducting vehicle sales transactions that involves producing substantially indelible audio and video recordings of such transactions.

It is another object of the present invention to provide a novel transaction recordation system and associated business method for conducting vehicle sales transactions that involves producing cataloged and easily retrieved audio and video recordings of such transactions.

It is another object of the present invention to provide a novel transaction recordation system and associated business method for conduction vehicle sales transactions that involves producing digitally recorded and stored audio and video recordings of such transactions for later retrieval in the event of a dispute as to what was and was not said or disclosed in the transaction.

In satisfaction of these and related objects, the present invention provides a novel transaction recordation system and associated business method which digitally records audio and video data from vehicle sales transactions, temporarily stores such recordings in computer memory or on semi-non-volatile storage (such as hard drive(s)), and thereafter transmits the recorded data to a secure, off-site server for secure, long-term storage, ready access at substantially any later time. The system includes, in its preferred embodiment; the use of a novel internet protocol created by the present inventors, which provides for uniquely secure communications between the clients and servers involved in use of the present system, as well as computer programs (software) which facilitate the various functions of the present system/invention as described below.

### BRIEF DESCRIPTION OF THE DRAWINGS

FIG. 1 depicts the dealership setup using a variation of the earlier version of the present inventors' system and method (the subject of the parent application). Here, each dealership “F&I Office” (finance and insurance office or department) is networked together and to a dealership server. Recorded transactions are stored immediately on this dealership central server, and are accessible via the central server within minutes of each transaction, so long as they remain on the server.

FIG. 2 depicts a dealership situation in which each F&I office may or may not be networked together, but each is equipped with high-speed internet access (cable, DSL, T-1, T-3, etc.). Each F&I office records customer transactions and, at a pre-determined time and interval, transmits the video and transaction data to a central computer running the present inventors' server software (“SMARTEYE SERVER”).

FIG. 3 depicts the set-up whereby each F&I office is be networked to a dealership server. Each F&I office records customer transactions, and transmits the video and transaction data to a computer in the dealership running the present server software (“SMARTEYE SERVER”). This internal dealership server would, in turn, upload the video and transaction data to a corporate computer running SMARTEYE SERVER. Using this method, each F&I office would not need Internet access, but the dealership server would use such to transmit data to the remote server.

FIG. 4 depicts the presently preferred embodiment of a system according to the present invention.

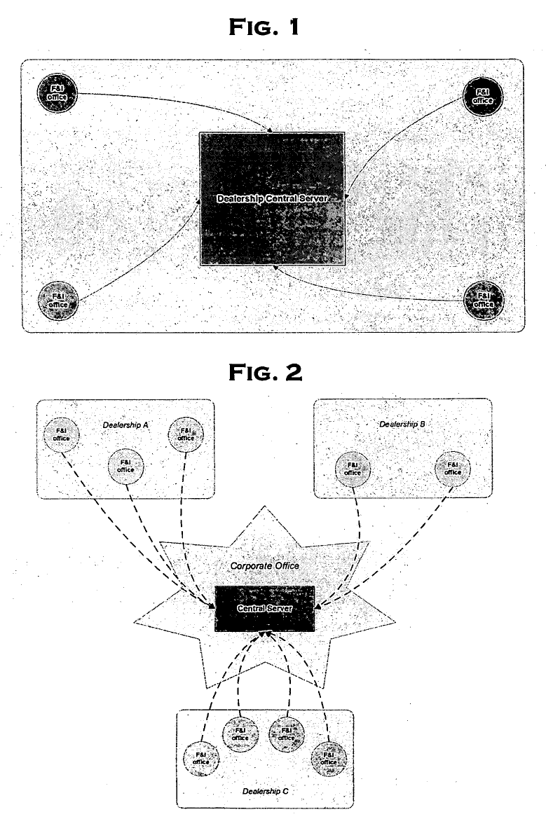

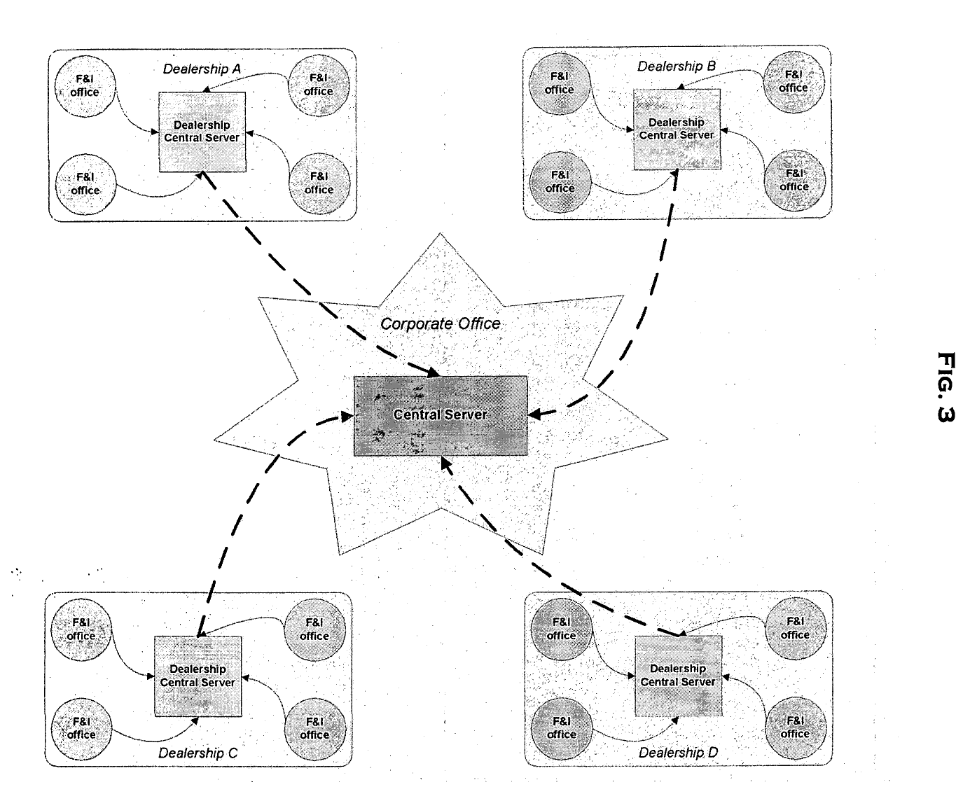

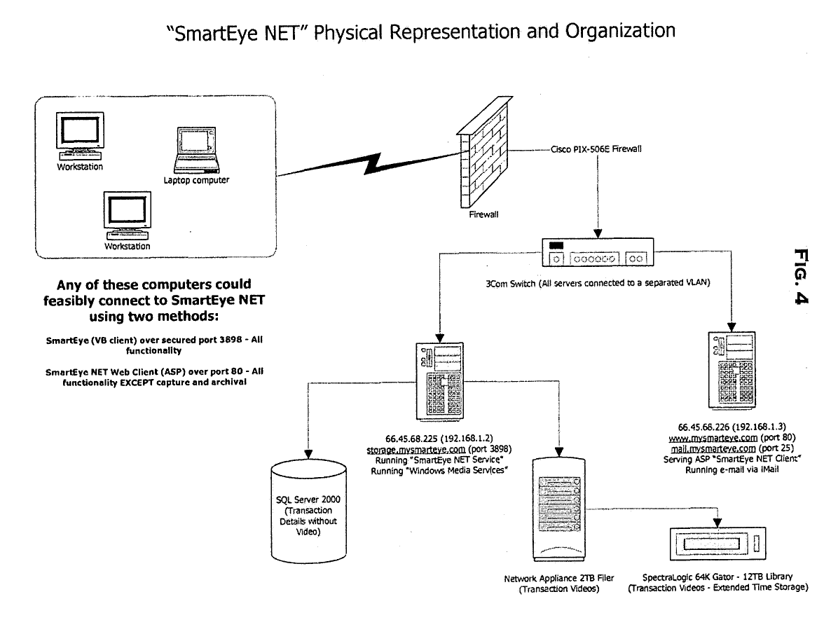

### DETAILED DESCRIPTION OF THE PREFERRED EMBODIMENT

The components involved in carrying out the subject business method can be categorized into two major classifications: hardware/equipment and proprietary software.

Hardware:
Wired Digital Video Camera or Wireless Digital; Video Camera/Digital Video Receiver;
Audio microphone;
CD-R, CD-RW, DVD-R, or DVD-RAM drive; and
Customary cables which allow for interface between hardware components, Microsoft Windows compatible personal computer with color monitor, mouse, and keyboard

Software:
Local client software for taking cataloging data through keyboard interface, initiating recording of a transaction, completing the recording session, storing data on the local computer, transmitting the data to the remote server for long-term storage and later retrieval by a user, and remotely accessing and retrieving for viewing or printing by a user the data earlier stored on the server. Such software is available from Innovative Aftermarket Systems, Inc. of Leander, Texas (assignee of the subject patent application) under the SMARTEYE trademark.
Server software which is resident on the remote server(s) to which data is transmitted by local users and which is administered by a service provider. The server software has certain functions, a subset of which correspond with functions of end users' local client software and which functions provide for the receipt, storage, archiving, search and retrieval of end user-generated data. Use of such software functionalities, on a subscription or contract basis is provided by Innovative Aftermarket Systems, Inc. of Leander, Texas (assignee of the subject patent application) under the SMARTEYE NET trademark.

The business method involves installation of a digital video camera on a wall or other suitable location in the financial closing office(s) of a vehicle dealership, where the camera can record the images of all people in the office. The camera is connected, either directly or through a wireless connection, to a personal computer via a USB port, or functionally equivalent interface. An audio microphone is also connected to the personal computer and is located in an area on the closing desk where it can record the voices of all people speaking in the office.

The PC will have installed the customary hardware drivers for interfacing with the video camera and the aforementioned disk drives.

After the hardware and software installation is complete, use of the recording system is straightforward.

The software (“local software”) on a computer of a local user (an automobile dealership, for example) is a client relative to server software as will be described below. The client has clickable “buttons” which initiate a recording session, first by bringing up an on-screen form for entering such items as the customer's name, address, vehicle purchased, time, date, etc. for cataloging the to-be-generated audio/video record of the transaction.

Once required fields in the on-screen form are complete, a “CONTINUE” (or equivalent) clickable “button” initiates actual recording. The digital images and audio stream, respectively, from the video camera and the computer microphone are recorded and stored into appropriate data files as the transaction goes on. An on-screen “COMPLETE” (or equivalent) clickable “button” terminates recording and stores the final data file with database information onto the designated short-term storage media (such as the computer's hard drive).

As earlier referenced, the locally stored data is at some point transmitted to a remote server for long-term storage and availability for later retrieval and review by users. Although conventional internet protocols may be used in these communications in lesser-preferred modes of the present invention, a proprietary internet protocol invented by the present inventors is used in implementing the present invention in its preferred mode.

The new protocol (assigned the SENIP [SMARTEYE NET INTERNET PROTOCOL], port 3898 designation by the Internet Assigned Numbers Authority [“IANA”]) affords enhanced security in data transfers. This, in turn, not only meets the goal of virtually every computer network user for confidentiality for confidentiality's own sake, but in the case of commercial and finance-related entities' communications which include their customers' confidential information, enhances their ability to comply with legal duties pertaining to confidentiality, such as under the Gramm-Leach-Bliley Act (15 U.S.C. §§ 6801 et seq.). The SENIP protocol command summary follows as APPENDIX A.

Integral of the present invention in its preferred mode is certain server software which is resident on the remote server(s) to which data is transmitted by local users and which is administered by a service provider. The server software has certain functions, a subset of which correspond with functions of end users' local client software and which functions provide for the receipt, storage, archiving, search and retrieval of end user-generated data.

The local client software communicates with the server through the TCP/IP protocol over a LAN, a WAN, or through the internet.

The server software, in the preferred mode of the present invention, includes a user-interface and server data management component which is involved in the daily interactions with end users, and a server administration component for management of the server functions by appropriate administrators of the service provider. The server software and its constituent elements and functions are more particularly described as follows:

The user-interface and server data management component (referred to as a “service”) is available for access and execution by end users through use of their client software. The service is installed on the host computer and is, in the preferred mode of the present invention, configured to be able to log on as a “system account” to eliminate any NTFS file permission problems.

The service, in its presently-envisioned, preferred mode, includes the following primary functionalities (with additional features being included as an administrator deems appropriate):
TCP/IP Listener—The service will listen on some port (which can be changed by the administrator) for a variety of activities from remote clients;
Login and Authentication—Before accepting any other requests, the remote client must be authenticated using some login and password scheme;
Accept Transaction/Video Data—If initiated by the client, the server can accept video (in the form of a WMV file) from the client, as well as transaction data (to be inserted into the server's database). Once the video data has completed transmission, the data file is copied to some location on the local server, and the transaction data is inserted into the local server database (including the updated video data location); and
Retrieve Video Data—The client software provides for entry of an EntryID, upon which the user-interface and server data management component locates the corresponding video data in it's data stores. Once the data is located, the file can either be transmitted completely to the client, or streamed to the client (depending on the option selected on the local client software); and
Logout—After completing any requests, an end users, through the local client software, logs out to close all connections with the server.

Additional functionalities for the user-interface and server data management component of the server software, in the presently preferred mode, include the following:
Archive—whether on an automated basis, or on-demand, the server will archive data to non-volatile storage media, such as optical disks, tapes, or the like;
Multiple Server Types—to enable the expected capturing of numerous transactions, the user-interface and server data management component is configured to communicate with either a Microsoft Jet database or a Microsoft SQL Server, the selection for which is configurable by an administrator;
Database Cleanup—the server is provided with the ability to perform some self-maintenance, including database cleanup and indexing, and disk storage defragmentation;
Retrieve Program Updates—end-users are provided the option of retrieving updates to their local client software. The server can transmit EXE, DLL, and OCX changes to the client machine;
Retrieve Database Defaults—To obviate custom, onsite configuration on a customer-by-customer basis, the local client software is permitted the retrieval of database defaults from the server, which, inturn, provides for uniform data capture methodology.

The server administration component will run on the server (on-demand) and will allow an administrator to configure and monitor the user-interface and server data management component. The server administration component will perform the following functions on-demand:
TCP/IP Configuration—the administrator configuration utility for configuring TCP/IP properties such as firewall and proxy configuration, as well as the selection of monitored port(s);
User Configuration—the identity of authorized users for controlling access to the system by way of specifying authorized login names, login passwords, even login times and the data upload and/or download rights of each respective end user;
Archive Configuration—the administration of the archival process, including the time and manner of data archiving, whether to non-volatile media, or even to another server;
Database Configuration—provides for the selection of database type (Microsoft Jet or SQL Server, for example) and other customary database parameters;
Database Cleanup Schedule—provides for scheduling, immediate initiation, or even inactivation of database clean-up functions;
Database Information—provides for the administrator's management and control of the number of transactions, size of video storage, average transmission speeds, etc., all viewable on-screen, by printed report, and/or via e-mail communications to the administrator's administrator's mailbox; and
User/Password Configuration—for tracking and security purposes, provides the administrator with the ability to set up user ID/password pairs to be used in the client authentication process, and which are stored in the central database along with the transaction data.

The server database is to be searchable as to any field in the original on-screen form. In other words, one can, for example, search for all transactions on a particular date, by a certain sales staff member, involving a particular customer, or involving a particular vehicle or product, provided such data fields were used in the initial data intake at the time of consumer transactions. Any retrieved record will reflect the data file name(s) or number(s) in which these respective recorded transactions are stored. Once having the file name(s) or number(s), a user can retrieve the file(s) from the server's database through network interface with the user-interface and server data management component of the server software.

Communications protocol setup information for end users is described in Appendix B below.

The subject system and business method allows for a permanent record of what happened during the actual closing of vehicle purchase transaction, supplementing the actual signed paperwork. This permanent record can be used in the event any discrepancies or disputes arise in the future regarding the transaction. This record benefits and protects all parties to the transaction.

Having a permanent video/audio record of the actual transaction helps ensure any written documents are not misrepresented, misinterpreted, or improperly disclosed to the customer.

Business management can monitor all transactions or spot check transactions to ensure employee compliance with fair business tactics and local, state, or federal laws. Additionally, management can use the record to improve the employee's ability to properly explain the transaction and/or complex documents and agreements related to the transaction.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

APPENDIX A

```
PROTOCOL COMMAND SUMMARY:
  LOGIN - Perform authentication
    LOGIN|<username>|<AES encrypted password>
    Returns:
      CONNECTED - Successfully connected and authenticated
      REFUSED_USERID - Refused because of unknown user ID
      REFUSED_PASSWORD - Refused because of invalid password
      REFUSED_DUPLICATE_LOGIN - Refused because this user is already logged in
      REFUSED_ERROR|<Detailed error information> - Refused for some other reason
      REFUSED_MAX_USERS - Refused because the server has reached maximum allowable capacity
      ALREADY_LOGGED_IN - Refused because the connection is already logged in
      INVALID_COMMAND_PARAMETERS - Refused because incorrect parameters were used
  DOWNLOAD_VIDEO - Client requests a download of video information (not database transaction) from server
    DOWNLOAD_VIDEO|<EntryID of video to download>
    Returns:
      READY_TO SEND|<Size of video file>|<File name> - Video transmission ready to transmit.
      (transmission starts after receiving DOWNLOAD_VIDEO_NOW)
      SEND_ERROR<Detailed error information> - Error locating or sending video file
      ACCESS_DENIED - Refused because the user has ‘read-only’ attribute set
      INVALID_COMMAND_PARAMETERS - Refused because incorrect parameters were used
  DOWNLOAD_VIDEO_NOW - Client tells server that it is ready to download video information from server
    DOWNLOAD_VIDEO_NOW|<File name>
  STREAM_VIDEO - Client streams video information from server without downloading first
    STREAM_VIDEO|<EntiyID of video to download>
    Returns:
      READY_TO_STREAM|<URL and file name> - Video transmission ready to transmit (transmission
      occurs through Windows Media Server using the Windows Media Server protocols)
      STREAM_ERROR|<Detailed error information> - Error locating or sending video file
      ACCESS_DENIED - Refused because the user has ‘read-only’ attribute set
      INVALID_COMMAND_PARAMETERS - Refused because incorrect parameters were used
  UPLOAD_VIDEO - Client uploads video information (not database transaction) to server
    UPLOAD_VIDEO|<EntrylD of video to upload>|<Size of video to upload>
    Returns:
      READY_TO_RECEIVE - Server ready to receive video. Client can begin transmission immediately
      RECEIVE_ERROR|<Detailed error information> - Server cannot receive for some reason
      ACCESS_DENIED - Refused because the user has ‘read-only’ attribute set
      INVALID_COMMAND_PARAMETERS - Refused because incorrect parameters were used
    After transmission, returns:
      RECEIVE_OK - Server received the file, the size of the tile matches, and the file was saved in the
      database
      RECEIVE_FAILED|<Detailed error information> - Server did not successfully receive or insert the file
  DATABASE_SELECT - Client submits SQL to search the server database. Server returns the filename of the XML
  file.
    DATABASE_SELECT|<SQL Statement>
    Returns:
      DATABASE_SELECT_OK|<Size of XML data file>|<Data file name (XML)> - The query completed
      successfully. The data is written to an XML file on the server, that can then be retrieved by
      DATABASE_SELECT_DOWNLOAD
      DATABASE_SELECT_FAILED|<Detailed error information> - The SQL statement was invalid or the
      select failed
      INVALID_COMMAND_PARAMETERS - Refused because incorrect parameters were used
  DATABASE_SELECT_DOWNLOAD - Client submits filename of XML dataset to download. Server writes file to
  client
    DATABASE_SELECT_DOWNLOAD|<File name of XML dataset>
    Transmit file to client
  DATABASE_EXECUTE - Client submits SQL to insert into the server database. Server returns records affected.
    DATABASE_EXECUTE|<SQL Statement>
    Returns:
      DATABASE_EXECUTE OK|<Number of records affected> - The SQL statement was valid, and the
      statement was executed
      DATABASE_EXECUTE FAILED|<Detailed error information> - The SQL statement was invalid or the
      execution failed
      ACCESS_DENIED - Refused because the user has ‘read-only’ attribute set
      INVALID_COMMAND_PARAMETERS - Refused because incorrect parameters were used
  LOGOUT - Close connections
    No return values
```

### Appendix B

### Communications Protocol Setup

The SmartEye NET Protocol, and Firewalls SmartEye communicates back and forth with SmartEye NET using a proprietary protocol which has been assigned the to the TCP port numbered 3898. This port number assignment was made by the Internet Assigned Numbers Authority (IANA) in October 2003. To verify, search for the “senip” protocol here. This “senip” protocol, which is very similar to HTTP or FTP, operates over a “socket”, which is an end to end connection between two computers. Before describing the firewall setup, it is important to understand one thing about sockets: the difference between source ports and destination ports. SmartEye NET is open for connections to port 3898. So for a SmartEye client, the destination port is always 3898. The source port, on the other hand, is not a static number. When a socket connection is established, the socket searches for an open port on the local TCP/IP stack. Note that only one program can use a single port at one time (fortunately there are 65,536 TCP/IP ports on every Windows system). Depending on what is running on the local machine, various source ports might be in use. What might at first seem strange is that the source port will almost never be port 3898. To understand why this is the case, consider this analogy to HTTP. If a user went to a Windows 2000 Server which was hosting web pages (on port 80), that user would definitely be able to surf other pages on the Internet. If the source port of the HTTP socket had to be port 80, there would be two programs (Internet Explorer and IIS in this example) attempting to use the same port. Because of this, your firewall should be configured to allow any inside source/host TCP port while allowing at least TCP port 3898 as a destination.

To allow SmartEye users to communicate with SmartEye NET, the SmartEye client must be able to go out to a remote server (Destination Port) using TCP port 3898. If an entry exists in the firewall for HTTP/port 80, this entry could be duplicated and changed to port 3898 instead as the two protocols are very similar.

### Windows Media and Firewalls

Windows Media is able to receive media broadcasts through either UDP or TCP connections. For Windows Media content, UDP is preferred as it is a more efficient connection for video. UDP does require more ports to be opened however. TCP is less efficient, but also requires only a single open port.

To allow SmartEye users to stream video using UDP connections, the SmartEye client must be able to go out to a remote server using TCP port 1755 and UDP port 1755. The remote server must be able to communicate back in to the client using UDP ports between 1024 and 5000. It is only necessary to open as many UDP ports as there are clients. So if there will only be a maximum of ten clients connecting at once to SmartEye NET, the only ports necessary are UDP ports 1024-1033

To allow SmartEye users to stream video using TCP connections only, the SmartEye client must be able to go out to a remote server using TCP port 1755. The remote server must be able to communicate back in to the client using TCP port 1755.

1. A business method for memorializing vehicle purchase transactions comprising the steps of:
selecting a video camera;
selecting computer means;
interfacing said video camera with said computer means;
installing local client software onto said computer means, which software effects initiation and termination of recordation of video images into a data file, associates user-inputted unique data specific to said purchase transaction with said data file upon saving of said data file to storage media, assigns a unique identifier to said file as said file is recorded to said storage media at termination of said recordation, periodically interfacing with a computer server operating server software and in such interfacing carrying out one or more of:
uploading one or more said data files to said computer server via a network interface between said local client computer and said computer server;
searching for previously uploaded data files using respective said unique identifiers;
viewing said data files located on said computer server;
downloading all or a portion of said data files located on said computer server;
installing said server software onto said computer server, said server software having functionality for:
interfacing with said local client software. via a network interface;
receiving said one or more data files from said computer operating said local client software;
storing said one or more data files in a searchable database wherein multiple data files may be searched with respect to said unique data identifier;
facilitating remote users' searching of said database for specific said data files using said local client software;
actuating said local client software for input of said user inputted unique data;
actuating said local client software for initiation of said recording of said transaction;
at the end of a transaction which is to be recorded, actuating said local client software for termination of said recordation and storage of said data file onto said storage media and of said record into said database;
actuating said local client software for interfacing with said server software to effect one or more server software functions.

2. The business method of claim 1 further comprising the steps of:
selecting an audio microphone;
interfacing said audio microphone with said local client computer;
including in said local client software, features for initiation of audio recording substantially simultaneous with said recordation of video images by said video camera, and storage of audio data into said data file, thereby producing an audio video record of said transaction.

3. A business method for memorializing vehicle purchase transactions comprising the steps of:
selecting an audio recording device;
selecting computer means;
interfacing said audio recording device with said computer means;
installing local client software onto said computer means, which software effects initiation and termination of recordation of audio recordings into a data file, associates user-inputted unique data specific to said purchase transaction with said data file upon saving of said data file to storage media, assigns a unique identifier to said file as said file is recorded to said storage media at termination of said recordation, periodically interfacing with a computer server operating server software and in such interfacing carrying out one or more of:
uploading one or more said data files to said computer server via a network interface between said local client computer and said computer server;
searching for previously uploaded data files using respective said unique identifiers;
viewing said data files located on said computer server;
downloading all or a portion of said data files located on said computer server;
installing said server-software onto said computer server, said server software having functionality for:
interfacing with said local client software via a network interface;
receiving said one or more data files from said computer operating said local client software;
storing said one or more data files in a searchable database wherein multiple data files may be searched with respect to said unique data identifier;
facilitating remote users' searching of said database for specific said data files using said local client software;
actuating said local client software for input of said user inputted unique data;
actuating said local client software for initiation of said recording of said transaction;
at the end of a transaction which is to be recorded, actuating said local client software for termination of said recordation and storage of said data file onto said storage media and of said record into said database;
actuating said local client software for interfacing with said server software to effect one or more server software functions.

5. A system for memorializing consumer transactions comprising:
local client computer means;
video camera means interfaced with said local client computer means;
local client software operating on said local client computer means, which software effects initiation and termination of recordation of video images into a data file, associates user-inputted unique data specific to said purchase transaction with said data file upon saving of said data file to storage media, assigns a unique identifier to said file as said file is recorded to said storage media at termination of said recordation, periodically interfacing with a computer server operating server software and in such interfacing carrying out one or more of:
uploading one or more said data files to said computer server via a network interface between said local client computer and said computer server;
searching for previously uploaded data files using respective said unique identifiers;
viewing said data files located on said computer server;
downloading all or a portion of said data files located on said computer server;
computer server means;
server software onto said computer server means, said server software having functionality for:
interfacing with said local client software via a network interface;
receiving said one or more data files from said computer operating said local client software;
storing said one or more data files in a searchable database wherein multiple data files may be searched with respect to said unique data identifier;
facilitating remote users' searching of said database for specific said data files using said local client software.

6. The system of claim 5 further comprising:
audio microphone recording means interfaced with said local client computer means; and
wherein said local client software further includes features for initiation of audio recording substantially simultaneous with said recordation of video images by said video camera means, and for storage of audio data into said data file, for producing an audio video record of said transaction.

7. The method of claim 1 wherein said interfacing between said local client computer means and said computer server means is through use of SENIP protocol.

8. The method of claim 2 wherein said interfacing between said local client computer means and said computer server means is through use of SENIP protocol.

9. The method of claim 3 wherein said interfacing between said local client computer means and said computer server means is through use of SENIP protocol.

10. The method of claim 4 wherein said interfacing between said local client computer means and said computer server means is through use of SENIP protocol.

11. The method of claim 5 wherein said interfacing between said local client computer means and said computer server means is through use of SENIP protocol.

12. The method of claim 6 wherein said interfacing between said local client computer means and said computer server means is through use of SENIP protocol.
